(19) United States
(12) Patent Application Publication
(10) Pub. No.: US 2023/0196910 A1
(43) Pub. Date: Jun. 22, 2023

(54) CO2 MANAGEMENT SYSTEM, CO2 MANAGEMENT METHOD, AND STORAGE MEDIUM

(71) Applicant: TOYOTA JIDOSHA KABUSHIKI KAISHA, Toyota-shi (JP)

(72) Inventors: Yasushi Hirata, Nagakute-shi (JP); Koseki Sugiyama, Sunto-gun (JP); Yoshinori Miyamoto, Susono-shi (JP); Kazuki Kaneko, Susono-shi (JP); Yusaku Onochi, Toyota-shi (JP); Daiki Yokoyama, Gotemba-shi (JP); Akihiro Kusumoto, Susono-shi (JP)

(21) Appl. No.: 18/046,973

(22) Filed: Oct. 17, 2022

(30) Foreign Application Priority Data
Dec. 17, 2021 (JP) 2021-205512

(51) Int. Cl. G08G 1/01; B01D 53/62

(52) U.S. Cl. CPC G08G 1/0141; B01D 53/62; G08G 1/0133; B01D 2257/504

(57) ABSTRACT

Road traffic volume information is acquired, and CO₂ recovery devices 30, 30a for recovering CO₂ exhausted into the air from vehicles on a road and drifting around the road are installed. Activation of the CO₂ recovery devices 30, 30a is controlled based on the road traffic volume information.

### FIELD

The present invention relates to a CO₂ management system, a CO₂ management method, and a storage medium.

### BACKGROUND

Publicly known is a management system designed to suppress the amount of emission of CO₂ into the air by recovering CO₂ in exhaust gas through CO₂ recovery devices mounted in vehicles, transmitting the amounts of CO₂ recovered by the CO₂ recovery device of the vehicles to a server, and having the server add up the amounts of CO₂ recovered by the CO₂ recovery device of the vehicles (for example, see Japanese Unexamined Patent Publication No. 2021-8852).

### SUMMARY

The management system disclosed in this patent publication covers recovery of CO₂ in order to prevent CO₂ from being exhausted into the air. This patent publication does not suggest recovering CO₂ that has been exhausted into the air.

The present invention provides one technique which can efficiently recover CO₂ exhausted into the air.

That is, according to the present invention, there is provided a CO₂ management system comprising an information acquisition unit for acquiring road traffic volume information and a CO₂ recovery device for recovering CO₂ exhausted into the air from vehicles on a road and drifting around the road, wherein activation of the CO₂ recovery device is controlled based on the road traffic volume information.

Further, according to the present invention, there is provided a CO₂ management method comprising acquiring road traffic volume information and controlling activation of a CO₂ recovery device for recovering CO₂ exhausted into the air from vehicles on a road and drifting around the road based on the road traffic volume information.

Furthermore, according to the present invention, there is provided a non-transitory computer-readable storage medium storing a program that causes a computer to acquire road traffic volume information and control activation of a CO₂ recovery device for recovering CO₂ exhausted into the air from vehicles on a road and drifting around the road based on the road traffic volume information.

According to the present invention, it is possible to efficiently recover CO₂ in the air by controlling activation of a CO₂ recovery device based on road traffic volume information.

### BRIEF DESCRIPTION OF DRAWINGS

FIG. 1A is a view schematically showing a “smart city”, and FIG. 1B is a view showing an electronic control device for a management server.

FIG. 2 is a view showing a road.

FIG. 3A is a view schematically showing the entirety of a CO₂ recovery device, and FIG. 3B is a side view of the CO₂ recovery device shown in FIG. 3A.

FIG. 4 is a view showing an electronic control device for the CO₂ recovery device.

FIG. 5 is a flow chart for CO₂ recovery management.

FIG. 6 is a view schematically showing the entirety of a mobile CO₂ recovery device.

FIG. 7 is a view schematically showing a tow vehicle for the mobile CO₂ recovery device.

FIG. 8 is a view showing a road.

FIG. 9 is a flow chart for CO₂ recovery management.

FIG. 10 is a flow chart for automated driving control.

FIG. 11 is a view showing a neutral network.

FIG. 12A and FIG. 12B are a view showing a table of a list of input parameters and a view showing the correspondence relationship between output values and states, respectively.

FIG. 13 is a view showing a training data set.

FIG. 14 is a flow chart for CO₂ recovery management.

FIG. 15 is a flow chart for CO₂ recovery management.

### DESCRIPTION OF EMBODIMENTS

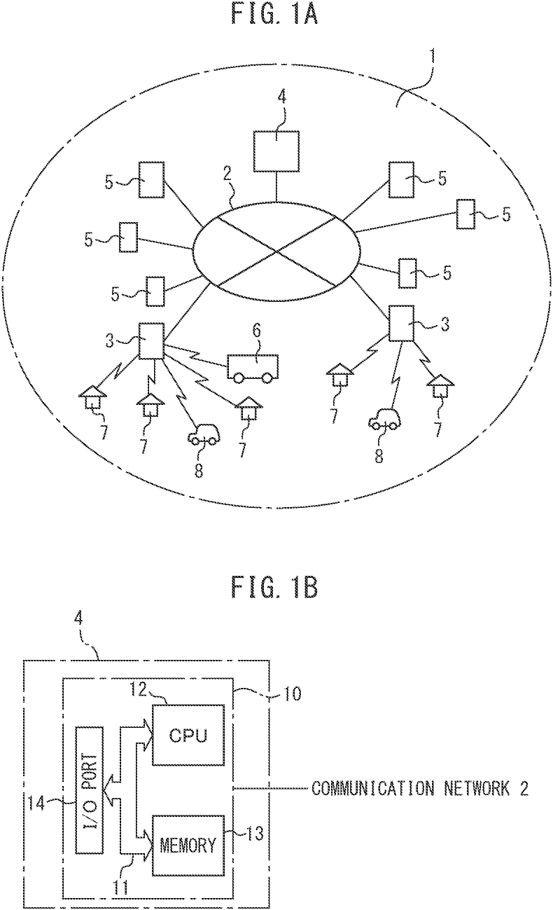

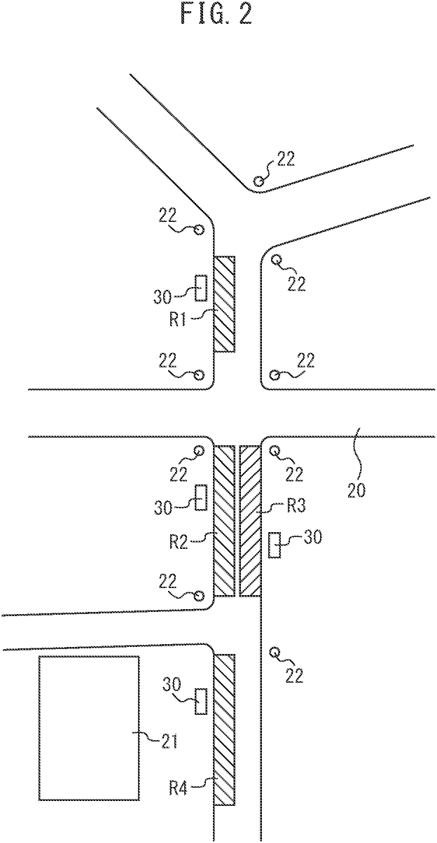

FIG. 1A schematically shows a “smart city”. The region surrounded by the dot and dash line represents the smart city 1. First, referring to FIG. 1A, what sort of region is meant by the smart city 1 will be explained simply. Referring to FIGS. 1A, 2 indicates a communication network, 3 a base station of the communication network 2, 4 a management server, 5 electricity, gas, or other infrastructure-related facilities and facilities such as stations, companies, factories, stores, hospitals, and schools, 6 public transportation such as automated buses, 7 residences, and 8 vehicles belonging to the residents of the residences 7. Various electronic devices in each facility 5 are connected to the communication network 2. Various electronic devices in the public transportation 6, vehicles 7, and residences 8 and portable terminals belonging to the residents of the residences 7 can wirelessly communicate with the base station 3. In this case, the electronic devices in the facilities 5, public transportation 6, vehicles 7, and residences and the portable terminals belonging to the residents of the residences 7 are managed by the management server 4.

In this regard, in general, a smart city is defined to be a city or region which solves various urban or regional problems and continuously creates new value by using advanced management (planning, development, management, operations, etc.) while incorporating ICT and other new technologies. On the other hand, in the present invention, in case where various devices in facilities 5, public transportation 6, vehicles 7, and residences 8 inside a region and the portable terminals belonging to the residents of the residences 7 are managed by the management server 4, this region is called the smart city 1.

Now then, in the embodiments according to the present invention, a plurality of CO₂ recovery devices are arranged distributed throughout the smart city 1 to recover CO₂ in the air. The activation of these CO₂ recovery devices are managed by the management server 4 so that the CO₂ in the air can be efficiently recovered. The management server 4 is shown in FIG. 1B. As shown in FIG. 1B, an electronic control unit 10 is provided inside the management server 4. The electronic control unit 10 comprises a digital computer and is provided with a CPU (microprocessor) 12, a memory 13 comprising a ROM and RAM, and an input/output port 14, which are mutually connected by a bidirectional bus 11. As shown in FIG. 1B, the electronic control unit 10 is connected to the communication network 2.

FIG. 2 schematically shows a map of a partial region of the smart city 1. In FIG. 2, 20 indicates roads, 21 indicates a facility such as a shopping center, and 22 indicates monitoring cameras for monitoring traffic. The images taken by these monitoring cameras 22 are transmitted to the management server 4, and the traffic volume of the vehicles 8 and the like at each road segment is calculated in the electronic control unit 10 of the management server 4.

In this regard, if the traffic volume of vehicles 8 and the like increases, the CO₂ exhausted into the air from the vehicles 8 and the like and drifting around roads will increase. Therefore, in the embodiments according to the present invention, the increased CO₂ is recoverd using CO₂ recovery devices. Example of such CO₂ recovery devices are indicated by reference sygns 30 in FIG. 3A and FIG. 3B. Note that FIG. 3B shows a side view of the CO₂ recovery device 30 shown in FIG. 3A. Referring to FIG. 3A and FIG. 3B, 31 indicates an air suction inlet, 32 an air suction pipe, 33 a solid adsorbent comprising activated carbon, zeolite, and the like for adsorbing CO₂, 34 a suction pump driven by a suction fan motor, 35 a CO₂ recovery pipe, 36 a secondary battery or fuel cell, and 37 an electronic control device.

If the suction pump 14 is driven, air containing CO₂ is sucked in from the air suction inlet 31 through the air suction pipe 32 and CO₂ contained in air is adsorbed on the solid adsorbent 33. At this time, the CO₂ recovery pipe 35 is closed. On the other hand, the CO₂ adsorbed on the solid adsorbent 33 desorbs when the pressure inside the solid adsorbent 33 is reduced or the solid adsorbent 33 is heated. Therefore, when collecting the CO₂ adsorbed on the solid adsorbent 33 into an external CO₂ recovery tank, the pressure inside the solid adsorbent 33 is reduced or the solid adsorbent 33 is heated and the CO₂ desorbed thereby is sent into the CO₂ recovery tank through the CO₂ recovery pipe 35.

Various methods for recovery of CO₂ are known. Other than the above-mentioned CO₂ recovery method using the solid adsorbent 33, a physical adsorption method using an amine or other liquid absorbent to make CO₂ be efficiently adsorbed on a solid adsorbent, a chemical absorption method using an amine or other liquid absorbent to absorb CO₂, a method using a separation membrane to separate CO₂, etc. are known. In the present invention, various known CO₂ recovery methods may be used in place of the CO₂ recovery method using the solid adsorbent 33.

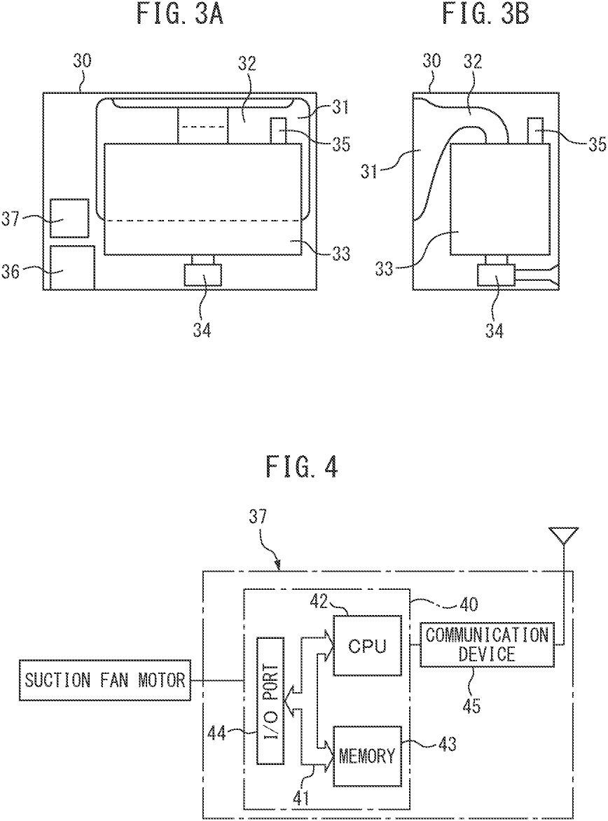

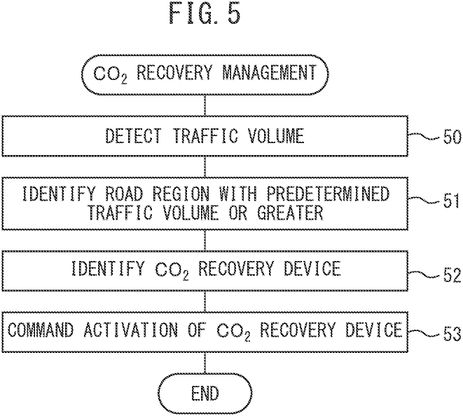

FIG. 4 shows the electronic control device 37 disposed inside the CO₂ recovery device 30. Referring to FIG. 4, an electronic control unit 40 is provided inside the electronic control device 37. The electronic control unit 40 comprises a digital computer and is provided with a CPU (microprocessor) 42, a memory 43 comprising a ROM and RAM, and an input/output port 44, which are mutually connected by a bidirectional bus 41. As shown in FIG. 4, the suction fan motor of the suction pump 34 is connected to the electronic control unit 40, the suction fan motor is controlled based on the output signal of the electronic control unit 40. On the other hand, the electronic control unit 40 is connected to a communication device 45, and the electronic control unit 40 can wirelessly communicate with the base station 3.

Now then, as explained above, if the traffic volume of vehicles 8 and the like increases, CO₂ exhausted into the air from the vehicles 8 and the like and drifting around roads will increase. In the embodiments of the present invention, the increased CO₂ is recovered by the CO₂ recovery devices 30. That is, the amount of CO₂ recovered per unit time by the CO₂ recovery device 30 when the CO₂ recovery device 30 is activated increases as the concentration of CO₂ in the air recovered by the CO₂ recovery device 30 increases. Therefore, the CO₂ recovery efficiency of the CO₂ recovery device 30 increases as the concentration of CO₂ in the air recovered by the CO₂ recovery device 30 increases.

On the other hand, if the traffic volume of vehicles 8 and the like in a certain road region increases, the concentration of CO₂ in the air around the road region with increased traffic volume will increase. Therefore, if CO₂ in the air around the road region with increased traffic volume is recovered by the CO₂ recovery device 30, CO₂ can be efficiently recovered by the CO₂ recovery device 30. Therefore, in the present invention, to efficiently recover CO₂ with the CO₂ recovery device 30, activation of the CO₂ recovery device 30 is controlled based on the road traffic volume information.

Next, referring to FIG. 2, a first embodiment of the present invention will be explained. In the first embodiment, the CO₂ recovery devices 30 are installed in advance in or near road regions in which there is a possibility of the traffic volume being greater than a predetermined traffic volume, the current traffic volume at each road region is detected, and CO₂ recovery devices 30 installed in or near road regions in which the detected current traffic volume is greater than the predetermined traffic volume are activated. In FIG. 2, if, for example, the road regions in which there is a possibility of the traffic volume being greater than the predetermined traffic volume are road regions R1, R2, R3, and R4 indicated by hatching, the CO₂ recovery devices 30 are disposed in the road regions R1, R2, R3, and R4 or in near road regions within a predetermined range of distance from the road regions R1, R2, R3, and R4. In this case, the predetermined range of distance is, for example, 10 meters.

On the other hand, in FIG. 2, for example, if the current traffic volume in the road region R2 is greater than the predetermined traffic volume, one or more CO₂ recovery devices 30 located in a near road region within the predetermined range of distance from the road region R2 are activated, and CO₂ recovery by the one or more CO₂ recovery devices 30 is started. CO₂ recovery by the CO₂ recovery devices 30 is continued while the traffic volume in the road region R2 is greater than the predetermined traffic volume. If the traffic volume in the road region R2 becomes less than the predetermined traffic volume, CO₂ recovery by the CO₂ recovery devices 30 is stopped.

FIG. 5 shows a routine for CO₂ recovery management for carrying out the first embodiment. This routine is performed at the electronic control unit 10 provided inside the management server 4. Referring to FIG. 5, first, at step 50, the traffic volumes at road regions R1, R2, R3, R4, etc. are detected based on images currently taken by the monitoring cameras 22. In this case, if the traffic volumes are being detected at a road management server separate from the management server 4, road traffic volume information provided by the road management server can be used.

Next, at step 51, a road region in which the current traffic volume is greater than the predetermined traffic volume is identified based on the traffic volumes at the road regions R1, R2, R3, R4, etc. detected at step 50. If a road region in which the traffic volume is greater than the predetermined traffic volume is identified, the routine proceeds to step 52 where the CO₂ recovery devices 30 located in the identified road region or in a near road region within the predetermined range of distance from the identified road region are identified. Next, at step 53, an activation command for the identified CO₂ recovery devices 30 is issued, and operation of the identified CO₂ recovery devices 30 are started.

In this way, in the first embodiment of the present invention, CO₂ recovery devices 30 located in road regions in which the traffic volume is greater than the predetermined traffic volume or in near road regions within the predetermined range of distance from such road regions are identified based on the road traffic volume information, and the identified CO₂ recovery devices 30 are activated.

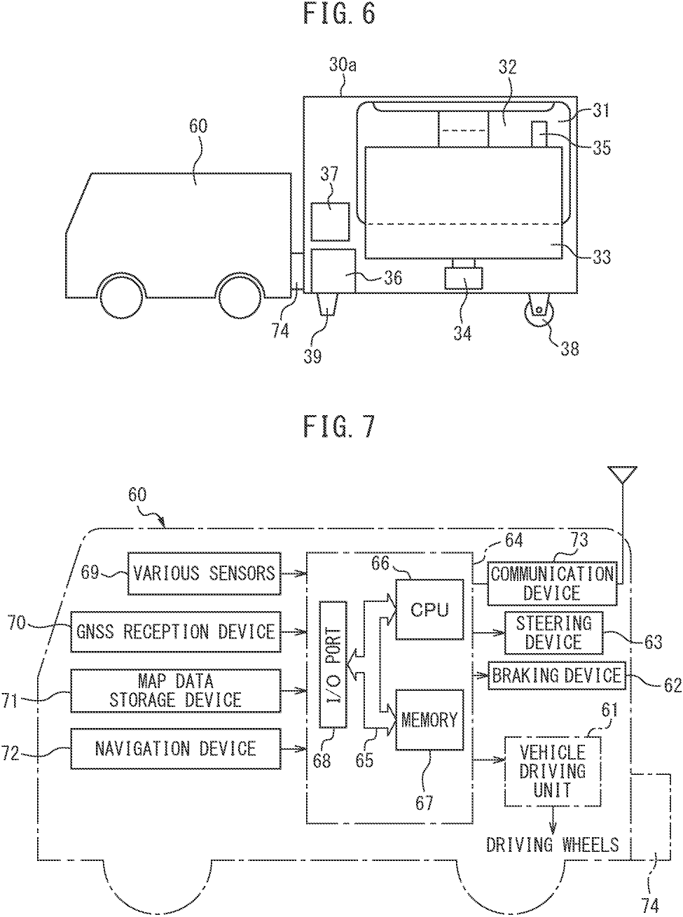

Next, referring to FIG. 6 to FIG. 11, a second embodiment of the present invention will be explained. In the second embodiment, a mobile CO₂ recovery device 30a shown in FIG. 6 is used in place of the stationary CO₂ recovery device 30 shown in FIG. 3A and FIG. 3B. The mobile CO₂ recovery device 30a, aside from being provided with wheels 38 for movement and a support base 39, has a similar structure to that of the stationary CO₂ recovery device 30 shown in FIG. 3A and FIG. 3B. In the example shown in FIG. 6, the CO₂ recovery device 30a is moved by an automated tow vehicle 60.

FIG. 7 schematically shows an example of the automated tow vehicle 60. Referring to FIG. 7, 61 indicates a vehicle driving unit for providing driving force to driving wheels of the tow vehicle 60, 62 indicates a braking device for braking the tow vehicle 60, 63 indicates a steering device for steering the tow vehicle 60, and 64 indicates an electronic control unit mounted inside the tow vehicle 60. As shown in FIG. 7, the electronic control unit 64 comprises a digital computer and is provided with a CPU (microprocessor) 66, a memory 67 comprising a ROM and RAM, and an input/output port 68, which are mutually connected by a bidirectional bus 65.

On the other hand, as shown in FIG. 7, the tow vehicle 60 is provided with various sensors 69 necessary for the tow vehicle 60 to perform automated driving, that is, sensors for detecting the state of the tow vehicle 60 and sensors for detecting the surroundings of the tow vehicle 60. In this case, an acceleration sensor, speed sensor, and azimuth angle sensor are used as the sensors for detecting the state of the tow vehicle 60, and a camera for capturing the view in front of the tow vehicle 60 and the like, a laser imaging detection and ranging device (LIDAR), a radar device, etc., are used as the sensors for detecting the surroundings of the tow vehicle 60. Further, the tow vehicle 60 is provided with a Global Navigation Satellite System (GNSS) reception device 70, a map data storage device 71, and a navigation device 72. The GNSS reception device 70 can detect the current location of the tow vehicle 60 (for example, the latitude and longitude of the tow vehicle 60) based on information acquired from a plurality of satellites. Therefore, it is possible to acquire the current location of the tow vehicle 60 with the GNSS reception device 70. A GPS reception device, for example, is used as the GNSS reception device 70.

The map data storage device 71 stores map data and the like necessary for the tow vehicle 60 to perform automated driving. The various sensors 69, GNSS reception device 70, map data storage device 71, and navigation device 72 are connected to the electronic control unit 64. Further, a communication device 73 capable of wirelessly communicating with the base station 3 is connected to the electronic control unit 64. Further, a coupling mechanism 74 for coupling the CO₂ recovery device 30a to the tow vehicle 60 is attached to the tow vehicle 60. The driving wheels are driven based on the output signal from the electronic control unit 64, the braking control for the tow vehicle 60 is performed by the braking device 62 according to the output signal from the electronic control unit 64, the steering control for the tow vehicle 60 is performed by the steering device 63 according to the output signal from the electronic control unit 64, and the coupling mechanism 74 is controlled according to the output signal from the electronic control unit 64.

The movement destination of the automated tow vehicle 60 is determined at the management server 4. The determined movement destination is transmitted through the communication network 2 to the communication device 73. If the communication device 73 receives the movement destination, a travel route for the tow vehicle 60 is retrieved using the navigation device 72, and the tow vehicle 60 undergoes automated travel while towing the CO₂ recovery device 30a along the retrieved travel route.

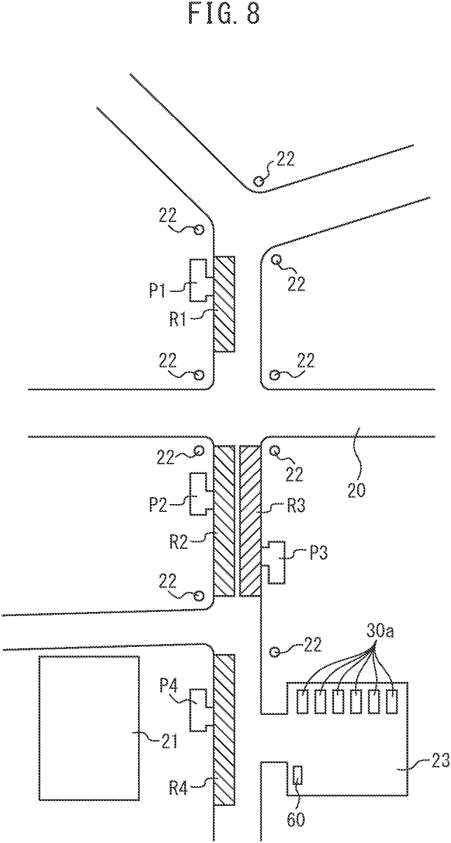

Next, the second embodiment will be explained referring to FIG. 8 schematically showing a map of a partial region of the smart city 1. In FIG. 8, if, for example, the road regions in which there is a possibility of the traffic volume becoming greater than the predetermined traffic volume are the road regions R1, R2, R3, and R4 indicated by the hatching, in the second embodiment, unlike in the first embodiment, installation locations P1, P2, P3, and P4 for installing the CO₂ recovery devices 30 are formed in the road regions R1, R2, R3, and R4 or in near road regions within the predetermined range of distance from the road regions R1, R2, R3, and R4. On the other hand, in the second embodiment, as shown in FIG. 8, a standby location 23 for the tow vehicle 60 and CO₂ recovery devices 30a is provided. The tow vehicle 60 and CO₂ recovery devices 30a are kept on standby at the standby location 23.

In the second embodiment, if, for example, the current traffic volume in the road region R2 is greater than the predetermined traffic volume, the CO₂ recovery device 30a on standby at the standby location 23 is transported by the tow vehicle 60 to the installation location P2 located in a near road region within the predetermined range of distance from the road region R2. When the CO₂ recovery device 30a arrives at the installation location P2, the CO₂ recovery device 30a is activated, and CO₂ recovery by the CO₂ recovery device 30a is started. CO₂ recovery by the CO₂ recovery device 30a is continued while the traffic volume in the road region R2 is greater than the predetermined traffic volume. If the traffic volume in the road region R2 becomes less than the predetermined traffic volume, CO₂ recovery by the CO₂ recovery device 30a is stopped.

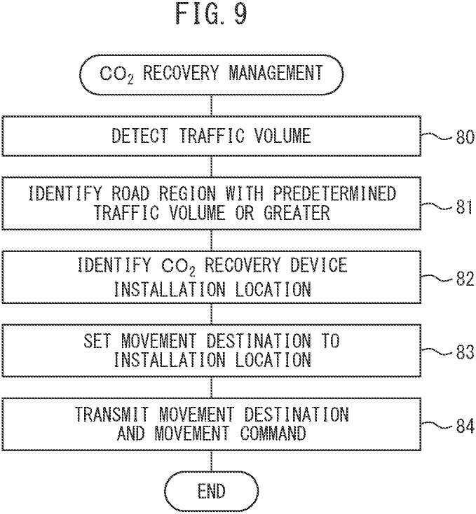

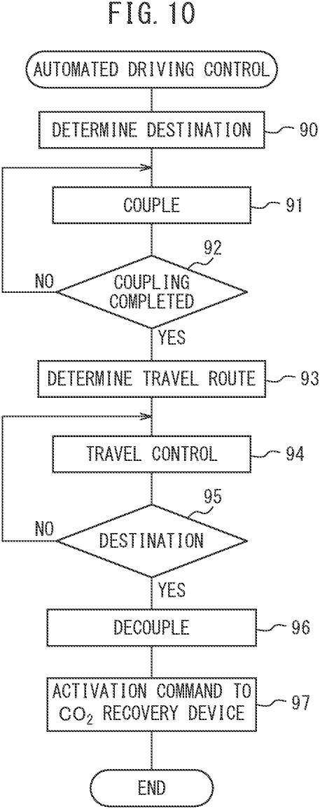

FIG. 9 shows a routine for CO₂ recovery management for carrying out the second embodiment. This routine is performed at the electronic control unit 10 provided inside the management server 4. Referring to FIG. 9, first, at step 80, the current traffic volumes at the road regions R1, R2, R3, R4, etc. are detected based on images taken by the monitoring cameras 22. In this case, if traffic volume is being detected at a road management server separate from the management server 4, road traffic volume information provided by the road management server can also be used.

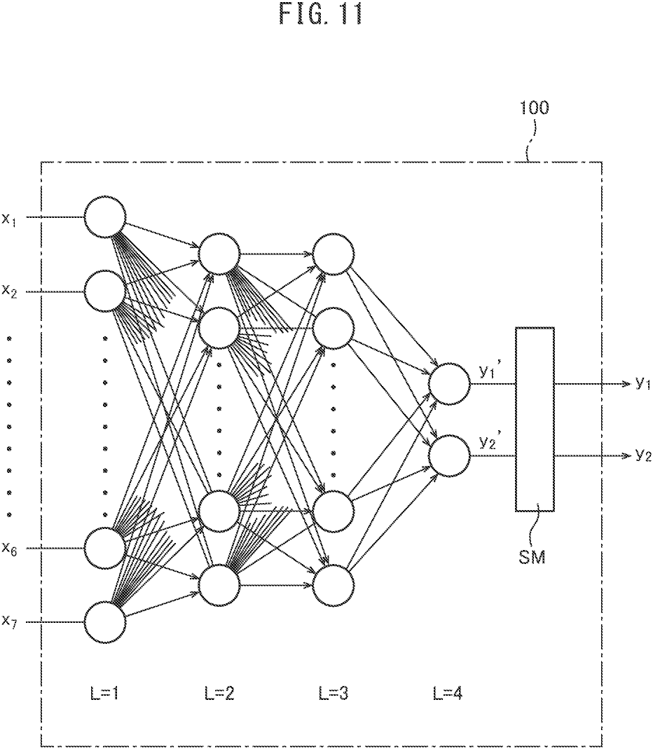

Next, at step 81, road regions in which the current traffic volume is greater than the predetermined traffic volume are identified based on the traffic volumes at the road regions R1, R2, R3, R4, etc. detected at step 80. If a road region in which the current traffic volume is greater than the predetermined traffic volume is identified, the routine proceeds to step 82 where the CO₂ recovery device 30a installation location P1, P2, P3, or P4 located in the identified road region or in a near road region within the predetermined range of distance from the identified road region is identified. Next, at step 83, the identified CO₂ recovery device 30a installation location P1, P2, P3, or P4 is made a movement destination, and the movement destination and a movement command are transmitted to the tow vehicle 60. If the tow vehicle 60 receives the movement destination and the movement command, the automated driving control routine shown in FIG. 10 is performed at the electronic control unit 10 provided in the tow vehicle 60.

Referring to FIG. 10, first, at step 90, the movement destination transmitted from the management server 4 is determined as a destination. Next, at step 91, at the standby location 23, coupling processing is performed to couple the tow vehicle 60 to the CO₂ recovery device 30a by automated driving. Next, at step 92, it is judged whether the coupling processing between the tow vehicle 60 and the CO₂ recovery device 30a is completed. If it is judged that the coupling processing between the tow vehicle 60 and the CO₂ recovery device 30a is not completed, the routine returns to step 91 where the coupling processing between the tow vehicle 60 and a CO₂ recovery device 30a continues. On the other hand, at step 92, if it is judged that the coupling processing between the tow vehicle 60 and the CO₂ recovery device 30a is completed, the routine proceeds to step 93.

At step 93, the travel route for the tow vehicle 60 from the current location to the destination is determined by the navigation device 72 based on the destination determined at step 90 and the current location of the tow vehicle 60 acquired by the GNSS reception device 70. Next, at step 94, travel control for the tow vehicle 60 is performed to prevent contact with other vehicles or pedestrians based on detection results of the camera for capturing the view in front of the tow vehicle 60 and the like, LIDAR, radar device, etc. Next, at step 95, it is judged whether the tow vehicle 60 has arrived at the destination determined at step 90. When it is judged that the tow vehicle 60 has not arrived at the destination, the routine returns to step 94 where automated driving of the tow vehicle 60 continues. On the other hand, if it is judged at step 95 that the tow vehicle 60 has arrived at the destination, the routine proceeds to step 96.

At step 96, processing is performed to decouple the tow vehicle 60 and the CO₂ recovery device 30a. If the tow vehicle 60 and the CO₂ recovery device 30a are decoupled, the CO₂ recovery device 30a becomes a state installed at the destination determined at step 90. Next, at step 97, an activation command to the CO₂ recovery device 30 is issued to start operation of the CO₂ recovery device 30. On the other hand, when the tow vehicle 60 and the CO₂ recovery device 30a are decoupled, the tow vehicle 60 returns to the standby location 23 by automated driving.

In this way, in the second embodiment of the present invention, the CO₂ recovery device 30a installation location P1, P2, P3, or P4 located in a road region in which the traffic volume is greater than the predetermined traffic volume or in a near road region within the predetermined range of distance from the road region is identified based on the road traffic volume information, and the mobile CO₂ recovery device 30a is transported to the identified installation location and activated.

Now, in the first embodiment and second embodiment explained up to now, based on the actual current traffic volume at road regions R1, R2, R3, R4, etc. detected by the monitoring cameras 22 or the current road traffic volume information provided by a road management server separate from the management server 4, activation of the CO₂ recovery devices 30 is controlled in the first embodiment and transportation and activation of the CO₂ recovery devices 30a are controlled in the second embodiment. In this case, it is also possible to predict the current traffic volume based on the history of past traffic volume and to control the activation of predicted CO₂ recovery devices 30 and control the transportation and activation of the CO₂ recovery devices 30a based on the predicted current traffic volume.

Next, referring to FIG. 11 to FIG. 13, an example of a method of predicting the current traffic volumes at the road regions R1, R2, R3, and R4 based on the history of past traffic volumes will be explained. In this example, a neural network 100 like that shown in FIG. 11 is used to predict the current traffic volumes at the road regions R1, R2, R3, and R4 based on the history of past traffic volumes. Referring to FIG. 11, in the neutral network 100, L=1 indicates an input layer, L=2 and L=3 hidden layers, and L=4 an output layer. In the neutral network 100, as shown in FIG. 11, the input layer (L=1) comprises seven nodes, and input values x₁, x₂, ..., x₆, x₇ of seven input parameters are input into the nodes of the input layer (L=1).

Further, in the neutral network 100, the number of nodes in the output layer (L=4) is set to two. Output values from the nodes in the output layer (L=4) are indicated by y₁′, y₂′. The output values y₁′, y₂′ are sent to a softmax layer SM and converted to corresponding output values y₁, y₂. The total of the output values y₁, y₂ is 1. Each output value y₁, y₂ represents a ratio relative to 1. Note that, in this case, it is also possible to not use the softmax layer SM , have there be one node in the output layer (L=4), and make the activation function at this node a sigmoid function to perform binary classification.

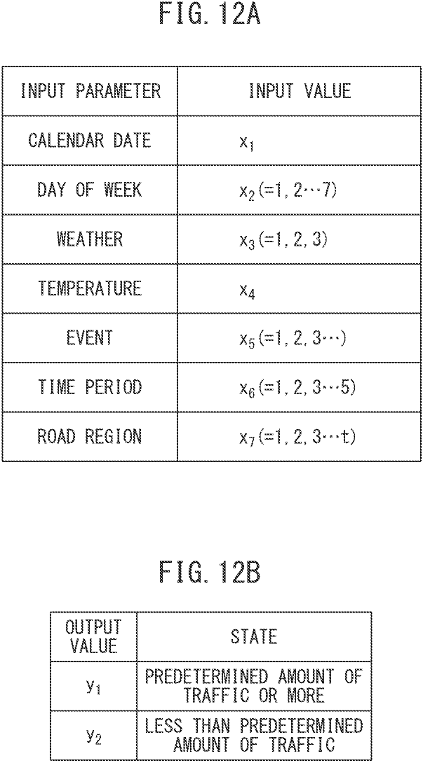

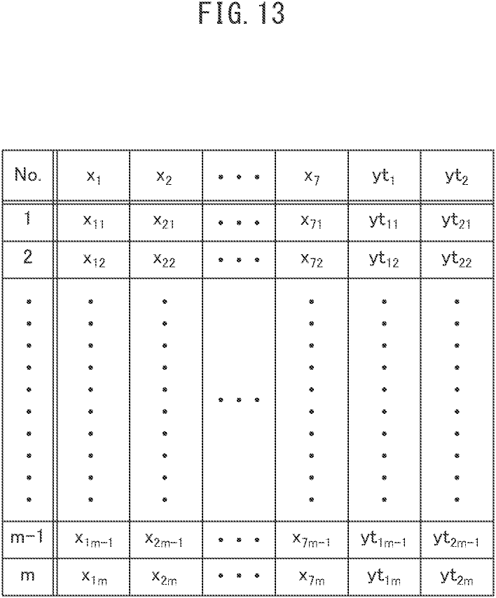

On the other hand, FIG. 12A shows a table listing input parameters for the neutral network 100. Factors influencing the traffic volume in the road regions R1, R2, R3, R4, etc. are used as input parameters. In the example shown in FIG. 12A, the calendar date, day of the week, weather, temperature, staging of events, and time periods are used as input parameters. Note that road regions R1, R2, R3, R4, etc. are also made input parameters.

Further, FIG. 12A shows input values x₁, x₂, ..., x₆, x₇ for the input parameters to the input layer (L=1). Referring to FIG. 12A, the input value x₁ representing calendar date is, for example, a numerical string of the calendar date in the order of year, month, and day. The input value x₂ representing the day of week is, for example, 1 if a Sunday, 2 if a Monday, etc. The input value x₃ representing the weather is, for example, 1 if sunny, 2 if raining, and 3 if snowing. The input value x₄ representing the temperature is, for example, a numerical value representing the temperature. The input value x₅ representing the staging of events is, for example, 1 if a bargain sale is being held in a certain facility in the smart city 1, 2 if a festival is being held in a certain location, 3 if a sports day is being held at a certain school, 4 if fixed hour traffic regulations are being enforced, etc. The input value x₆ representing the time period is, for example, set to 1, 2, ..., and “s” for increments of 10 minutes such as 1 if 0:00 to 0:10, 2 if 0:10 to 0:20, ..., and “s” (s=144) if 23:50 to 0:00. The input value x₇ representing the road regions R1, R2, R3, and R4 is 1 if the road region R1, 2 if the road region R2, ..., and “t” if the road region Rt.

On the other hand, FIG. 12B shows the correspondence relationship between the output values y₁, y₂ and states. In the example shown in FIG. 11 to FIG. 13, the neural network 100 is learned in weights so that the output value of the output value y₁ is 1 or a value near 1 and the output value of the output value y₂ is 0 or a value near 0 when it is predicted that the traffic volume will become greater than the predetermined traffic volume, and the output value of the output value y₂ is 1 or a value near 1 and the output value of the output value y₁ is 0 or a value near 0 when it is predicted that the traffic volume will be less than the predetermined traffic volume.

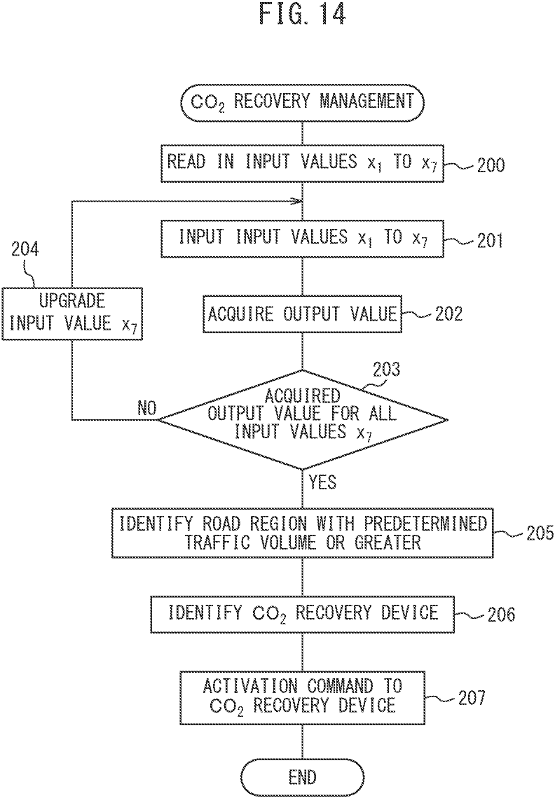

FIG. 13 shows a training data set created using input values x₁, x₂, ..., x₆, x₇ as the input parameters and training data, that is, truth label yt, to learn weights of the neutral network 100. In FIG. 13, the input values x₁, x₂, ..., x₆, x₇, as explained above, represent the calendar date, day of the week, weather, temperature, staging of events, time periods, and road regions R1, R2, R3, R4, etc. On the other hand, in FIG. 13, yt₁, yt₂ represent training data, that is, truth labels, for the output values y₁, y₂. That is, in FIG. 13, yt₁ represents a truth label when the traffic volume is greater than the predetermined traffic volume, and yt₂ represents a truth label when the traffic volume is less than the predetermined traffic volume. In this case, in the example shown in FIG. 11 to FIG. 13, the truth label yt₁ is 1 and the truth label yt₂ is zero when the traffic volume is greater than the predetermined traffic volume, and the truth label yt₂ is 1 and the truth label yt₁ is zero when the traffic volume is less than the predetermined traffic volume.

Now then, in the example shown in FIG. 11 to FIG. 13, it is measured if the traffic volume is greater than the predetermined traffic volume for each time increment of 10 minutes and the road regions R1, R2, R3, R4, etc. over several years, for example. The input values x₁ representing the calendar date, the input values x₂ representing the day of week, the input values x3 representing the weather, the input values x₄ representing the temperature, the input values x₅ representing the staging of events, the input values x₆ representing the time period, the input values x₇ representing the road regions R1, R2, R3, R4, etc., and the values of the truth labels yt₁, yt₂ over several years are stored in the memory 13 of the electronic control unit 10 provided in the management server 4. In the electronic control unit 10, a training data set like that shown in FIG. 13 is created based on the stored values. In the training data set, “m” pieces of data representing the relationship between the input values x₁, x₂, ..., x₆, x₇ and the truth labels yt₁, yt₂ are acquired. For example, in the second data entry (No. 2), the acquired input values x₁₂, x₂₂, ..., x₆₂, x₇₂ and the acquired truth labels yt₁₂, yt₂₂ are listed and, in the m-1th data entry (No. m-1), the acquired input values x₁ₘ₋₁, x₂ₘ₋₁, ..., x₆ₘ₋₁, x₇ₘ₋₁ and the acquired truth labels yt₁ₘ₋₁, yt₂ₘ₋₁ are listed.

Next, the method for leaning weights of the neural network 100 using the training data set will be simply explained. The leaning of weights of the neutral network 100 is performed at the electronic control unit 10 provided in the management server 4. For example, first, the input values x₁, ..., x₇ in the first entry of the training data set (No. 1) are input to the nodes of the input layer (L=1) of the neutral network 100. The output values y₁‘, y₂′ are output from the nodes of the output layer of the neutral network 100 at this time. The output values y₁‘, y₂‘ are sent to the softmax layer SM and converted to corresponding output values y₁, y₂. Next, a cross entropy error E representing the error between the output values y₁, y₂ and the truth labels yt₁, yt₂ is calculated, and the weights of the neutral network 100 are learned using the back propagation so that the cross entropy error E becomes small.

When the leaning of weights of the neutral network 100 based on data in the first entry of the training data set (No. 1) is complete, the leaning of weights of the neural network 100 based on the data in the second entry (No. 2) of the training data set is performed using the back propagation. Similarly, the leaning of weights of the neural network 100 is sequentially performed until the mth entry of the training data set (No. m). The leaning of weights of the neutral network 100 is repeatedly performed until the cross entropy error E becomes less than a set error which is set in advance. Ultimately, a traffic volume predictive model comprised of the trained neutral network 100 which can predict traffic volume is created. This predictive model is created in the electronic control unit 10 provided in the management server 4. If the input values x₁, ..., x₇ are input into this predictive model, the output value y₁ becomes 1 or a value near 1 when the traffic volume is predicted to become greater than the predetermined traffic volume, and the output value y₂ becomes 1 or a value near 1 when the traffic volume is predicted to be less than the predetermined traffic volume. Therefore, it is possible to predict whether the traffic volume will be greater than the predetermined traffic volume from the output value y₁ and output value y₂ in the predictive model.

Next, a third embodiment which is a modification of the first embodiment will be explained. In the third embodiment, when it is predicted that the traffic volume at a road region R1, R2, R3, R4, etc. will become greater than the predetermined traffic volume, the CO₂ recovery device 30 located in a near road region within the predetermined range of distance from the road region in which it is predicted that the traffic volume will become greater than the predetermined traffic volume is activated, and CO₂ recovery by the CO₂ recovery device 30 is started.

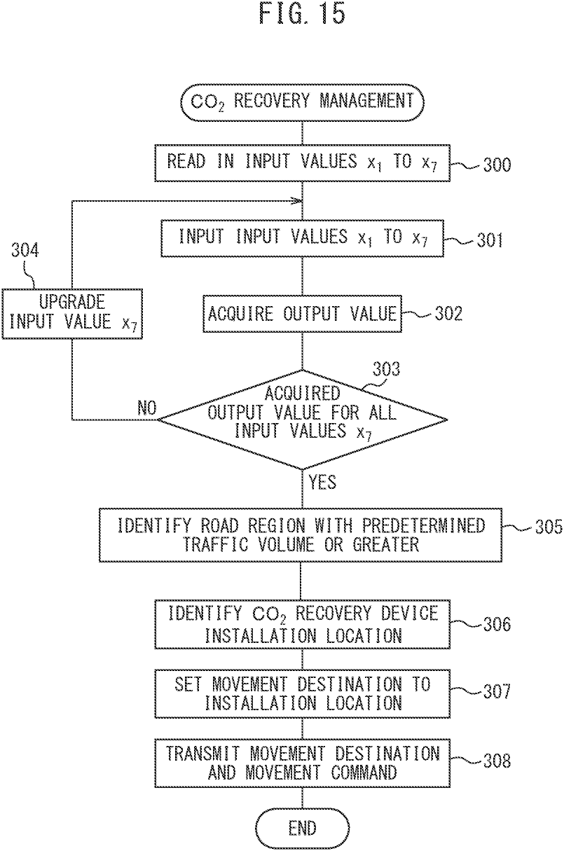

FIG. 14 shows a routine for CO₂ recovery management for carrying out the third embodiment. This routine is performed at the electronic control unit 10 provided inside the management server 4. Referring to FIG. 14, first, at step 200, for example, the input value x₁ representing today’s calendar date, the input value x₂ representing today’s day of the week, the input value x₃ representing the current weather, the input value x₄ representing the current temperature, the input value x₅ representing current state of staging of events, the input value x₆ representing the current time period, and the input value x₇ representing the road region R1, R2, R3, R4, etc., are acquired. In this case, the current weather and current temperature may be the weather and temperature based on a weather forecast.

Next, at step 201, the input values x₁, ..., x₆ and, for example, the input value x₇ (=1) representing the road region R1 are input into the above-mentioned predictive model. At this time, the output value y₁ and output value y₂ for the road region R1 are output from the predictive model. As a result, the output value y₁ and output value y₂ for the road region R1 are acquired as shown in step 202. Next, at step 203, it is judged whether the output value y₁ and output value y₂ are acquired for all road regions R₁, R₂, R₃, R₄, etc. When it is judged that the output value y₁ and output value y₂ have not been acquired for all road regions R1, R2, R3, R4, etc., the routine proceeds to step 204 where the input value x₇ representing the road region is updated. In this example, the input value x₇ representing the road region is made the input value x₇ (=2) representing the road region R2. Next, the routine proceeds to step 201.

At step 201, the input values x₁, ..., x₆ and the input value x₇ (=2) representing the road region R2 are input into the above-mentioned predictive model. At this time, the output value y₁ and output value y₂ for the road region R2 are output from the predictive model. As a result, the output value y₁ and output value y₂ for the road region R2 are acquired as shown in step 202. If the output value y₁ and output value y₂ are acquired for all road regions R1, R2, R3, R4, etc. in this way, the routine proceeds to step 205 where, from the output value y₁ and output value y₂ acquired for the road regions R1, R2, R3, R4, etc. a road regions in which the current traffic volume is predicted to become greater than the predetermined traffic volume is identified. If the road regions in which the traffic volume will be greater than the predetermined traffic volume is identified, the routine proceeds to step 206 where the CO₂ recovery device 30 located in the identified road region or a near road region within the predetermined range of distance from the identified road regions is identified. Next, at step 207, an activation command to the identified CO₂ recovery device 30 is issued, and the operation of the identified CO₂ recovery devices 30 is started.

In this way, in the third embodiment of the present invention, a prediction unit for predicting a road region and time period in which the traffic volume will be greater than the predetermined traffic volume based on a history of road traffic volume information is provided, the CO₂ recovery device 30 located in a road region in which it is predicted that the traffic volume will be greater than the predetermined traffic volume or a near road region within the predetermined range of distance from the road region is identified, and the identified CO₂ recovery device 30 is activated at the predicted time period. In this case, the electronic control unit 10 provided in the management server 4 constitutes the prediction unit. Further, in this case, the prediction unit predicts road regions and time periods in which the traffic volume will be greater than the predetermined traffic volume based on calendar date, day of week, weather, temperature, and state of staging of events.

Next, a fourth embodiment which is a modification of the second embodiment will be explained. In the fourth embodiment, when the traffic volume at the road region R1, R2, R3, R4, etc., is predicted to become greater than the predetermined traffic volume, the CO₂ recovery device 30a on standby at the standby location 23 is transported by the tow vehicle 60 to the installation location P1, P2, P3, or P4 located in a near road region within a predetermined range of distance from the road region in which it is predicted that the traffic volume will become greater than the predetermined traffic volume.

FIG. 15 shows a routine for CO₂ recovery management for carrying out the fourth embodiment. This routine is performed at the electronic control unit 10 provided inside the management server 4.

Referring to FIG. 15, first, at step 300, for example, the input value x₁ representing today’s calendar date, the input value x₂ representing today’s day of the week, the input value x₃ representing the current weather, the input value x₄ representing the current temperature, the input value x₅ representing the current state of staging of events, the input value x₆ representing the current time period, and the input value x₇ representing the road regions R1, R2, R3, R4, etc. are acquired. In this case as well, the current weather and current temperature may be the weather and temperature based on a weather forecast.

Next, at step 301, the input values x₁, ...., x₆ and, for example, the input value x₇ (=1) representing the road region R1 are input into the above-mentioned predictive model. At this time, the output value y₁ and output value y₂ for the road region R1 are output from the predictive model. As a result, the output value y₁ and output value y₂ for the road region R1 are acquired as shown in step 302. Next, at step 303, it is judged whether the output value y₁ and output value y₂ have been acquired for all road regions R1, R2, R3, R4, etc. When it is judged that the output value y₁ and output value y₂ have not been acquired for all road regions R1, R2, R3, R4, etc., the routine proceeds to step 304 where the input value x₇ representing the road region is updated. In this example, the input value x₇ representing the road region is the input value x₇ (=2) representing the road region R2. Next, the routine proceeds to step 301.

At step 301, the input values x₁, ..., x₆ and the input value x₇ (=2) representing the road region R2 are input into the above-mentioned predictive model. At this time, the output value y₁ and output value y₂ for the road region R2 are output from the predictive model. As a result, the output value y₁ and the output value y₂ for the road region R2 are acquired as shown in step 302. If the output value y₁ and output value y₂ have been acquired for all road regions R1, R2, R3, R4, etc., in this way, the routine proceeds to step 305 where, from the output value y₁ and output value y₂ acquired for road regions R1, R2, R3, R4, etc, a road region in which the current traffic volume is predicted to become greater than the predetermined traffic volume is identified. If a road region in which the traffic volume will become greater than the predetermined traffic volume is identified, the routine proceeds to step 306 where the CO₂ recovery device 30a installation location P1, P2, P3, or P4 located in the identified road region or a near road region within the predetermined range of distance from the identified road region is identified. Next, at step 307, the identified CO₂ recovery device 30a installation location P1, P2, P3, or P4 is made a movement destination, and the movement destination and a movement command are transmitted to the tow vehicle 60. If the tow vehicle 60 receives the movement destination and the movement command, the automated driving control routine shown in FIG. 10 is performed at the electronic control unit 10 provided in the tow vehicle 60, and automated driving control for the tow vehicle 60 similar to in the second embodiment is performed.

In this way, in the fourth embodiment of the present invention, a prediction unit for predicting a road region and time period in which the traffic volume will become greater than the predetermined traffic volume based on a history of road traffic volume information is provided, the CO₂ recovery device 30a installation location located in a road region in which it is predicted that the traffic volume will become greater than the predetermined traffic volume or a near road region within the predetermined range of distance from the road region is identified, and the mobile CO₂ recovery device 30 is transported to the identified installation location and activated at the predicted time period. In this case, the electronic control unit 10 provided in the management server 4 constitutes the prediction unit. Further, in this case, the prediction unit predicts road regions and time periods in which the traffic volume will become greater than the predetermined traffic volume based on calendar date, day of week, weather, temperature, and state of staging of events.

In this way, the CO₂ management system according to the present invention comprises an information acquisition unit for acquiring road traffic volume information and a CO₂ recovery device 30, 30a for recovering CO₂ exhausted into the air from vehicles on a road 20 and drifting around the road 20, and activation of the CO₂ recovery device 30, 30a is controlled based on the road traffic volume information. In this case, the electronic control unit 10 in the management server 4 constitutes the information acquisition unit in the embodiments of the present invention.

Further, in the present invention, there is provided a CO₂ management method comprising acquiring road traffic volume information and controlling activation of the CO₂ recovery device 30, 30a for recovering CO₂ exhausted into the air from vehicles on the road 20 and drifting around the road 20 based on the road traffic volume information. Further, in the present invention, there is provided a non-transitory computer-readable storage medium storing a program that causes a computer to acquire road traffic volume information and control activation of the CO₂ recovery device 30, 30a for recovering CO₂ exhausted into the air from vehicles on the road 20 and drifting around the road 20 based on the road traffic volume information.

What is claimed is:

1. A CO₂ management system comprising an information acquisition unit for acquiring road traffic volume information and a CO₂ recovery device for recovering CO₂ exhausted into the air from vehicles on a road and drifting around the road, wherein activation of the CO₂ recovery device is controlled based on the road traffic volume information.

2. The CO₂ management system according to claim 1, wherein the CO₂ recovery device located in a road region in which traffic volume is greater than a predetermined traffic volume or located in a near road region within a predetermined range of distance from the road region is identified based on the road traffic volume information, and the identified CO₂ recovery device is activated.

3. The CO₂ management system according to claim 1, wherein an installation location of the CO₂ recovery device located in a road region in which traffic volume is greater than a predetermined traffic volume or located in a near road region within a predetermined range of distance from the road region is identified based on the road traffic volume information, and a mobile CO₂ recovery device is transported to the identified installation location and activated.

4. The CO₂ management system according to claim 1, comprising a prediction unit for predicting a road region and time period in which traffic volume will become greater than a predetermined traffic volume based on a history of road traffic volume information, wherein the CO₂ recovery device located in a road region in which traffic volume is predicted to become greater than the predetermined traffic volume or located in a near road region within a predetermined range of distance from the road region is identified, and the identified CO₂ recovery device is activated at the time period.

5. The CO₂ management system according to claim 4, wherein the prediction unit predicts a road region and time period in which traffic volume will become greater than the predetermined traffic volume based on a calendar date, day of week, weather, temperature, and state of staging of event.

6. The CO₂ management system according to claim 1, comprising a prediction unit for predicting a road region and time period in which traffic volume will become greater than a predetermined traffic volume based on a history of road traffic volume information, wherein a CO₂ recovery device installation location located in a road region in which traffic volume is predicted to become greater than the predetermined traffic volume or located in a near road region within a predetermined range of distance from the road region is identified, and a mobile CO₂ recovery device is transported to the identified installation location and activated in the time period.

7. The CO₂ management system according to claim 6, wherein the prediction unit predicts a road region and time period in which traffic volume will become greater than the predetermined traffic volume based on a calendar date, day of week, weather, temperature, and state of staging of event.

8. A CO₂ management method comprising acquiring road traffic volume information and controlling activation of a CO₂ recovery device for recovering CO₂ exhausted into the air from vehicles on a road and drifting around the road based on the road traffic volume information.

9. A non-transitory computer-readable storage medium storing a program that causes a computer to:
acquire road traffic volume information, and
control activation of a CO₂ recovery device for recovering CO₂ exhausted into the air from vehicles on a road and drifting around the road based on the road traffic volume information.
